(19) United States
(12) Patent Application Publication
(10) Pub. No.: US 2007/0203307 A1
(43) Pub. Date: Aug. 30, 2007

(54) POLYMERS OF ORGANICALLY MODIFIED SILOXANE RESINS WITH RELEASE EFFECT

(75) Inventors: Pedro Cavaleiro, Viersen (DE); Markus Hallack, Schermbeck (DE); Hans-Leo Karminski, Essen (DE); Christiane Volmer-Sawitowski, Essen (DE); Udo Schiemann, Essen (DE)

Correspondence Address: FROMMER LAWRENCE & HAUG, 745 FIFTH AVENUE- 10TH FL., NEW YORK, NY, 10151, US

(73) Assignee: Goldschmidt GmbH, Essen (DE)

(21) Appl. No.: 11/677,821

(22) Filed: Feb. 22, 2007

(30) Foreign Application Priority Data
Feb. 24, 2006 (DE) 10 2006 008 590.6

(51) Int. Cl. C08L 83/04; B32B 27/00

(52) U.S. Cl. 525/474; 524/588

(57) ABSTRACT

The present invention relates to compositions for producing release-effect coatings, to a process for preparing the compositions, and to substrates coated with them.

This application claims benefit under 35 U.S.C. 119(a) of German patent application DE 10 2006 008 590.6, filed on 24 Feb. 2006.

Any foregoing applications including German patent application DE 10 2006 008 590.6, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

Citation or identification of any document in this application is not an admission that such document is available as prior art to the present invention.

The present invention relates to storage-stable compositions for producing release-effect coatings, to substrates coated with them, to a process for preparing the compositions, and to their use.

Coatings based on silicone resin and silicone oil, and their use as release coatings, have been known for a long time. For instance, U.S. Pat. No. 2,606,510 describes the use of silicone resins, U.S. Pat. No. 2,462,242 the use of silicone oils.

The use of hydroxy-functional polymethylphenylsilicone resins for release coatings on baking trays is described in U.S. Pat. No. 2,672,104.

The combination of silicone resins and silicone oils for release coatings has been used in the art for a number of years. Combinations of this kind are particularly suitable, owing to the release effect, across a wide range of foodstuffs, and owing to the good resistance properties. An example is the combination described in U.S. Pat. No. 3,002,946 of 80-98% by weight binder, 1-10% by weight hydroxy-terminal polymethylphenylsiloxane oil, and 1-19% by weight methyl-endcapped polydiorganosiloxane oil.

Further patents deal with the improvement of the formulation, as described in U.S. Pat. No. 3,002,946. These improvements are in some cases, as described in U.S. Pat. No. 3,925,276, improvements to the silicone resin, or, as in U.S. Pat. No. 4,302,512, the improvement of the silicone oil. European Patent EP 0 239 049 (U.S. Pat. No. 4,677,147) describes the optimization of the catalysts in the production of the release coating.

The use of silicone polyester is described in combination with laminar solids in the UK Patent GB 2 152 946 A and in combination with linear siloxanes in German Patent DE 37 284 14 A (U.S. Pat. No. 4,898,772).

A further patent deals with the improvement of the formulation, as described in EP 1 072 660 (U.S. Pat. No. 6,734,271). These improvements optimize the compatibility of the silicone resin with the silicone oil, by adding hydroxyl-containing polyesters to the formulation.

The mixing of the polysiloxane resins with release effect is typically carried out using dispersing and/or milling equipment which produces an energy input of less than 20 kJ/m³.

In the art, the phase stability of the abovementioned coatings is inadequate. Moreover, the art desires improved release effects.

It is an object of the present invention to provide a phase-stable, i.e., storage-stable, release-effect polysiloxane resin and the release coating produced from it, having improved properties with respect to the release effect, and also a process for producing these release coatings. The release coating must be nontoxic and must be easy to apply to coated or uncoated substrates.

The aforementioned object is achieved by means of a composition for producing release-effect coatings which comprises polysiloxane resins, organically modified polysiloxanes and nanoscale solids.

The invention accordingly provides compositions for producing release coatings, comprising
(A) 100 parts by weight of one or more polysiloxane resins of the general formula

RₐSi (OR′)_{b}O_{(4-a-b)/2}
where 0<a<2, 0<b<2, and a+b<4,
(B) 0.05 to 10 parts by weight of one or more linear and/or branched polysiloxanes of the formula

R″O—[R′″₂Si—O]ₙ—R″
and
(C) 5 to 80 parts by weight of a hydroxyl-containing polyester,
   where
   Rₐ, R′, R″, and R′″ each independently of one another are an alkyl radical having 1 to 8 carbon atoms or an aromatic radical having 6 to 20 carbon atoms, and
   n is a number in the range from 4 to 5000,
   wherein
(D) 2 to 80 parts by weight of one or more nanoscale solids are used as well (in another embodiment of the invention the range is selected from the group consisting of 10 to 50 parts by weight and 20 to 30 parts by weight).

Component (A) (RₐSi(OR′)_{b}O_{(4-a-b)/2}) is a polysiloxane resin where 0<a<2, 0<b<2, and a+b<4, R′ being an alkyl group, composed of 1 to 8 carbon atoms, or an aromatic moiety having 6 to 20 carbon atoms. Examples of alkyl groups are C₁ to C₄ alkyl such as methyl, ethyl, isopropyl, n-butyl, and tert-butyl. An example of an aromatic moiety is phenyl. In one embodiment of the invention, R are methyl or phenyl or mixtures of methyl and phenyl. R′ is an alkyl group composed of 1 to 8 carbon atoms, such as methyl or ethyl. In another embodiment of the invention R′ is an alkyl group composed of 1 to 4 carbon atoms.

The preparation of silicone resins of component (A) has been known for a long time in the literature (see W. Noll in “Chemie und Technologie der Silicone”, Verlag Chemie, Weinheim (1968)) and is described, for example, in German Patent DE 34 12 648 C, fully incorporated herein by reference.

The polysiloxane (component (B)) of the formula R″O—[R′″₂Si—O]ₙ—R″ is also commonly referred to as a release oil. R″ is, for example, a hydrogen radical or an alkyl group, having 1 to 8 carbon atoms. R″ can also be an —Si(CH₃)₃ group. In another embodiment of the invention R″ is an alkyl group composed of 1 to 4 carbon atoms.

Within the molecule of component (B) R′″ may be identical or different and may be a phenyl group or an alkyl group, composed of 1 to 8 carbon atoms. In another embodiment of the invention R′″ is an alkyl group composed of 1 to 4 carbon atoms. In yet another embodiment of the invention R′″ is methyl or phenyl or mixtures of methyl and phenyl. A small fraction of R′″ may also be a polysiloxane side chain —[R′″₂Si—O]ₙ—R″, so that slightly branched structures of release oil are possible as well as linear structures. On average n is 4 to 5000.

Likewise suitable as component (B) are pure polydimethylsiloxanes and polydimethylsiloxanes in which up to 20 mol % of the methyl radicals have been replaced by phenyl radicals. Siloxanes of this kind contain no reactive groups (R″=—Si(CH₃)₃).

The hydroxyl-containing polyester (component (C)), which is described, for example, in DE 37 28 414 C1 (U.S. Pat. No. 4,898,772), fully incorporated by reference, is prepared, for example, by esterification reaction from polycarboxylic acids and polyalcohols or by transesterification reaction of polycarboxylic esters with polyalcohols, with an amount-of-substance ratio COOR:C—OH, or COOH:C—OH, of >1.0.

A solid (component (D)) for the purposes of the present invention may in principle be any solid organic or inorganic nanoscale particle.

It is further noted that the invention does not intend to encompass within the scope of the invention any previously disclosed product, process of making the product or method of using the product, which meets the written description and enablement requirements of the USPTO (35 U.S.C. 112, first paragraph) or the EPO (Article 83 of the EPC), such that applicant(s) reserve the right and hereby disclose a disclaimer of any previously described product, method of making the product or process of using the product.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. patent law, e.g., they allow for elements not explicitly recited, but exclude elements that are found in the prior art or that affect a basic or novel characteristic of the invention.

By nanoscale for the purposes of the invention are meant solids having an average aggregate size or agglomerate size selected from the sizes of ≦800 nm, ≦500 nm, ≦150 nm, and around 60 nm, and/or having a primary particle size selected from the sizes of ≦100 nm, ≦50 nm, ≦15 nm and ≦1 nm.

Examples of such solids are pigments, fillers, dyes, ceramic materials, magnetic materials, metals, biocides, agrochemicals, and drugs, which can be brought, or reduced in size, to the appropriate particle-size distribution.

In one embodiment of the invention, the solids are pigments, as specified, for example, in the “Colour Index, Third Edition, Volume 3; The Society of Dyers and Colourists (1982)” and in the subsequent, revised editions.

Examples of pigments are inorganic pigments, such as carbon blacks, titanium dioxides, zinc oxides, Prussian blue, iron oxides, cadmium sulfides, chromium pigments, such as chromates, molybdates, and mixed chromates and sulfates of lead, zinc, barium, calcium, and mixtures thereof. Further examples of inorganic pigments are given in the book “H. Endriss, Aktuelle anorganische Bunt-Pigmente, Vincentz Verlag, Hanover (1997)”.

Examples of organic pigments are those from the group of the azo, disazo, condensed azo, Naphtol, metal complex, thioindigo, indanthrone, isoindanthrone, anthanthrone, anthraquinone, isodibenzanthrone, triphendioxazine, quinacridone, perylene, diketopyrrolopyrrole, and phthalocyanine pigments. Further examples of organic pigments are given in the book “W. Herbst, K. Hunger, Industrial Organic Pigments, VCH, Weinheim (1993)”.

In another embodiment of the invention, the solids are fillers, such as talc, kaolin, silicas, barites, and lime; ceramic minerals, such as aluminum oxides, silicates, zirconium oxides, titanium oxides, boron nitrides, silicon nitrides, boron carbides, mixed silicon-aluminum nitrides, and metal titanates; magnetic materials, such as magnetic oxides of transition metals, such as iron oxides, cobalt-doped iron oxides, and ferrites; metals such as iron, nickel, cobalt, and their alloys; and biocides, agrochemicals, and drugs, such as fungicides, for example.

In another embodiment of the invention, the solids are powders, which where appropriate are in surface-modified form.

There are no limits on the nature or origin of these powders which can be used in accordance with the invention. In one embodiment of the invention, the powders can be produced from solids in the form of a metal, metal oxide, metal boride, metal carbide, metal nitride, metal carbonate, metal phosphate, metal chalcogenide, metal sulfate and/or metal halide.

The metal may be selected from Li, Na, K, Rb, Cs, Be, Mg, Ca, Sr, Ba, Sc, Y, La, Ce, Pr, Nd, Sm, Eu, Gd, Tb, Ti, Zr, Hf, V, Nb, Ta, Cr, Mo, W, Mn, Fe, Co, Ni, Cu, Zn, Ag, Cd, Hg, B, Al, Ga, In, Te, Se, Ti, Si, Ge, Sn, Pb, P, As, Sb and/or Bi. For the purposes of the invention the intention is that the nonmetals B, Si, and P should also be included.

In another embodiment of the invention, the solid has been produced from a metal oxide which comprises the elements Si, Al, Ti, Fe, Ce, In, Sb, Zn, Sn, Y and/or Zr. It may be particularly advantageous for the amino-functional solids to be produced from solids such as the mixed metal oxides indium tin oxide, antimony tin oxide; mixed oxides with a matrix domain structure, as described for example in EP-A-1 284 485 (U.S. Pat. No. 6,746,767) or in EP-A-1 468 962 (US Patent Application Publication 2004-0229036).

In another embodiment of the invention, the solid may also comprise a metal oxide prepared by precipitation, as described for example in WO 00/14017 (U.S. Pat. No. 6,533,966).

The proportions of components (A), (B), (C), and (D) may be varied within wide ranges.

Component (B) can be present in amounts of selected from the ranges consisting of about 0.05 to about 10 parts by weight, about 0.5 to about 8 parts by weight about 4 to about 6 parts by weight of polysiloxane (B), based on 100 parts by weight of component (A).

Component (C) can be present in amounts of selected from the ranges consisting of about 5 to about 80 parts by weight, about 10 to about 80 parts by weight and about 30 to about 70 parts by weight of polysiloxane (C), based on 100 parts by weight of component (A).

Modifying the silicone resin with a polyester by transesterification raises the boiling water resistance and lowers the thermoplasticity of the cured coating. There are likewise improvements in pigmentability and in the gloss of the coating.

Component (D) can be present in amounts of selected from the ranges consisting of about 2 to about 80 parts by weight, about 5 to about 60 parts by weight and about 15 to about 40 parts by weight of polysiloxane (D), based on 100 parts by weight of component (A)+(B)+(C).

A process for homogenizing components (A) to (D), together or in any order—for example, first components (A) to (C) and then (D)—can take place using the known dispersing and/or milling equipment of the prior art.

In one embodiment of the invention, the coating compositions are obtainable by reacting components (A), (B), (C), and (D) with one another simultaneously. Participants in this reaction may also be the solids containing reactive groups on the surface. These components are reacted with a degree of conversion selected from the ranges of 20% to 80% and 25% to 80%, based on component (B) (forming a precondensate).

Surprisingly it has been found that by this means it is possible to achieve a distinct improvement in the phase stability of the coating. The separation tendency of the polysiloxane (B) is significantly lowered as a result.

A sufficient degree of conversion can be ascertained, for example, by withdrawing a portion from the reaction mixture, drying it on a glass plate, with heating where appropriate, and determining the transparency of the coating on the glass plate using standard methods. A clear, transparent film is generally an indicator of sufficient conversion. From the amount of condensate removed by distillation, furthermore, it is possible to determine precisely the conversion in the reaction.

It is a further object of the present invention to improve the resistance of the release coatings to mechanical stresses, such as the abrasion resistance and scratch resistance, for example.

In one embodiment of the invention, the release control compositions of the invention provide a reduction in abrasion resistance relative to composition without one or more nanoscale solids selected from the ranges consisting of about 20% to about 95%, about 25% to about 80% and about 30% to about 65%.

Surprisingly this is accomplished by homogenizing the constituents using high-pressure homogenizers, such as the apparatus known, for example, under the name “wet-jet-mill”.

In apparatus of this kind, two predispersed suspension streams under high pressure are released via a nozzle. The dispersion jets impinge exactly on one another, and the particles are milled themselves. In another embodiment the preliminary dispersion is likewise placed under high pressure, but the particles collide against armored wall regions. The operation can be repeated as often as desired in order to obtain smaller particle sizes.

Apparatus of this kind has been used to date only to disperse chemically unitary oxides, such as zinc oxide, silicon dioxide, and aluminum oxide (GB-A-2 063 695, EP-A-876 841 (U.S. Pat. No. 5,967,964), and EP-A-773 270 (U.S. Pat. No. 5,904,159) in organic or aqueous solvents. The milling and dispersing of filled release coatings, which form the basis for this invention, has not been described to date using these apparatus.

This was all the more surprising given that conventional high-energy mixing appliances, such as rotor-stator systems or Ultra-Turrax machines or stirred ball mills or planetary kneaders/mixers, for example, are not suitable.

The invention accordingly further provides a process for preparing a composition for producing release coatings having improved abrasion resistance and scratch resistance, which comprises preparing components (A), (B), (C), and (D) using a high-pressure homogenizer. The invention gives preference to homogenizers which produce at least an energy input of at least 200 kJ/m³.

Further subject matter of the invention is apparent from the claims.

The compositions can be applied by knifecoating, dipping or spray application to the substrate that is to be coated, and, after the baking operation, give a coating having an outstanding release effect. By baking the composition (precondensate) at temperatures and under conditions of the kind described in DE 37 28 414 C1, for example, it is possible to obtain complete conversion in the reaction.

Baking is advantageously carried out at an elevated temperature using a catalyst. Suitable catalysts, as described in EP 0 092 701 A (U.S. Pat. No. 4,452,961), are, for example, metal catalysts based on magnesium, cobalt, iron, aluminum, titanium, lead, zinc or tin, for example, in the form for example of their laurates, octoates, acetates, acetylacetonates, neodecanates or naphthalates. In one embodiment of the invention, the organotin catalysts are dibutyltin dilaurate, dibutyltin dioctoate or dibutyltin diacetate. In another embodiment of the invention, the organotitanium catalyst are tetra(n-butyl)titanate or tetra(isopropyl)titanate.

If desired, colored coating compositions can be obtained by formulation with pigments (having particle sizes in the μm range). Additives from the group of solvents, adhesion promoters, rheology control agents, stabilizers or additives allow the formulation to be adapted to the particular mode of application. Through the incorporation of PTFE (polytetrafluoroethylene) powder it is possible, for example, to improve the release effect further.

The release agents of the invention are suitable for a multiplicity of substrates in all fields of application in the home, technology, and industry, such as for example antifouling paints for ships, aircraft and space-vehicle casings, equipment for sport, leisure, and commerce, such as helmets, clothing, tarpaulins, and lamps.

In one embodiment of the invention, the substrates which can be coated with the aid of the present invention are, for example, strip heaters, grill rods, metal baking sheets, baking tins, pans, metal pots, and the like.

The invention is further described by the following non-limiting examples which further illustrate the invention, and are not intended, nor should they be interpreted to, limit the scope of the invention.

### EXAMPLES

### Reference Example 1

### Preparation of Silicone Resin (A):

The alkoxypolysiloxane of the formula (C₆H₅)_{0.45}(CH₃)_{0.65}—Si(OC₂H₅)_{0.28}O_{1.31} (A) is described in DE 37 28 414 C (U.S. Pat. No. 4,898,772) and was prepared in accordance with DE 34 12 648 A from phenyltrichlorosilane, methylethoxypolysiloxane, ethanol, and water. The silicone resin had an ethoxy content of 11.9% by weight.

### Example 1

### (Inventive Composition)

263 g of a hydroxyl-containing polyester (C) having an OH number of 560 mg KOH/g (prepared from trimethylolpropane and dimethyl terephthalate with catalysis in accordance with DE 37 28 414 A) (U.S. Pat. No. 4,898,772) were reacted with 1000 g of the silicone resin (A) from Reference Example 1 and with 781 g of xylene, 381 g of diethylene glycol dimethyl ether and 0.3 g of tetra(n-butyl)titanate at 135° C. to a reaction conversion at which the composition, when dried on a glass plate, gave a clear, transparent coating. The amount of ethanol removed by distillation, 73 g, corresponded to a conversion of 60% in the reaction. The silicone polyester resin was subsequently admixed with 252 g of Aerosil® Alu 65 (Degussa AG) (CAS No. 12415-34-8 which has a primary particle size of 19 nm), with 2.2 g of a polydimethylsiloxane (B) of the formula C₂H₅O—[Si(CH₃)₂O]₃₀—C₂H₅, and with 5 g of tetra(n-butyl)titanate.

### Example 2

### (Inventive Composition)

263 g of a hydroxyl-containing polyester (C) having an OH number of 560 mg KOH/g (prepared from trimethylolpropane and dimethyl terephthalate with catalysis in accordance with DE 37 28 414 A) (U.S. Pat. No. 4,898,772) were reacted with 1000 g of the silicone resin (A) from Reference Example 1 and with 781 g of xylene, 381 g of diethylene glycol dimethyl ether and 0.3 g of tetra(n-butyl)titanate at 135° C. to a reaction conversion at which the composition, when dried on a glass plate, gave a clear, transparent coating. The amount of ethanol removed by distillation, 73 g, corresponded to a conversion of 60% in the reaction. The silicone polyester resin was subsequently admixed with 402 g of Aerosil® Alu 65 (Degussa AG), with 2.2 g of a polydimethylsiloxane (B) of the formula C₂H₅O—[Si(CH₃)₂O]₃₀—C₂H₅, and with 5 g of tetra(n-butyl)titanate.

### Example 3

### (Inventive Composition)

A mixture of methyl phenyl silicone resin and polydiorganosiloxane according to Example 1 from EP 0 239 049 C (U.S. Pat. No. 4,677,147) was admixed with 20% by weight of Aerosil® 9200 (CAS No. 68611-44-9 which has a primary particle size of 34 nm)

### Example 4

### (Inventive Composition)

A mixture of methyl phenyl silicone resin and polydiorganosiloxane according to Example 1 from EP 0 239 049 C (U.S. Pat. No. 4,677,147) was admixed with 30% by weight of Aerosil® 9200.

### Comparative Example C 1

### (Noninventive Composition)

263 g of a hydroxyl-containing polyester (C) having an OH number of 560 mg KOH/g (prepared from trimethylolpropane and dimethyl terephthalate with catalysis in accordance with Example 1.1 from DE 37 28 414 A (U.S. Pat. No. 4,898,772)) were reacted with 1000 g of the silicone resin (A) from Reference Example 1 and 2.5 g of a polydimethylsiloxane (B) of the formula C₂H₅O—[Si(CH₃)₂O]₃₀—C₂H₅ in 781 g of xylene, 381 g of diethylene glycol dimethyl ether and 0.3 g of tetra(n-butyl) titanate at 135° C. to a reaction conversion at which the composition, when dried on a glass plate, gave a clear, transparent coating. The amount of ethanol removed by distillation, 74 g, corresponded to a conversion of 60% in the reaction.

### Comparative Example C 2

### (Noninventive Composition)

263 g of a hydroxyl-containing polyester (C) having an OH number of 560 mg KOH/g (prepared from trimethylolpropane and dimethyl terephthalate with catalysis in accordance with Example 1.1 from DE 37 28 414 A (U.S. Pat. No. 4,898,772)) were reacted with 1000 g of the silicone resin (A) from Reference Example 1 and 2.5 g of a polydimethylsiloxane (B) of the formula

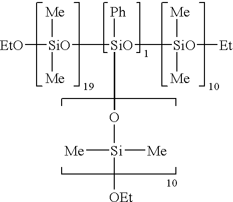

in 781 g of xylene, 381 g of diethylene glycol dimethyl ether and 0.3 g of tetra(n-butyl)titanate at 135° C. to a reaction conversion at which the composition, when dried on a glass plate, gave a clear, transparent coating. The amount of ethanol removed by distillation, 74 g, corresponded to a conversion of 60% in the reaction.

### Comparative Example C 3

### (Noninventive Composition)

263 g of a hydroxyl-containing polyester (C) having an OH number of 560 mg KOH/g (prepared from trimethylolpropane and dimethyl terephthalate with catalysis in accordance with DE 37 28 414 A (U.S. Pat. No. 4,898,772)) were reacted with 1000 g of the silicone resin (A) from Reference Example 1 and with 781 g of xylene, 381 g of diethylene glycol dimethyl ether and 0.3 g of tetra(n-butyl)titanate at 135° C. to a reaction conversion at which the composition, when dried on a glass plate, gave a clear, transparent coating. The amount of ethanol removed by distillation, 73 g, corresponded to a conversion of 60% in the reaction. The silicone polyester resin was subsequently admixed with 2.2 g of a polydimethylsiloxane (B) of the formula C₂H₅O—[Si(CH₃)₂O]₃₀—C₂H₅, and with 5 g of tetra(n-butyl)titanate. The formulation corresponded to preparation Z--1 from DE 37 28 414 C.

### Comparative Example C 4

### (Noninventive Composition)

A mixture of methyl phenyl silicone resin and polydiorganosiloxane in accordance with Example 1 from EP 0 239 049 C (U.S. Pat. No. 4,677,147).

### Procedure 1 (Production of Coatings with Low Dispersing Energy)

The compositions were prepared by mixing the components as per Table 1. Mixing took place with a homogenizer (Dispermate) which produces an energy input of 15 kJ/m³.

TABLE 1
Formulation of compositions (in weight fractions)
produced using a Dispermate.

| | Coating | | | | | | | |
|---|---|---|---|---|---|---|---|---|
| | 1 | 2 | 3 | 4 | 5 | 6 | 7 | 8 |
| Composition | | | | | 500 g | | | |
| of Example 1 | | | | | | | | |
| Composition | | | | | | 500 g | | |
| of Example 2 | | | | | | | | |
| Composition | | | | | | | 500 g | |
| of Example 3 | | | | | | | | |
| Composition | | | | | | | | 500 g |
| of Example 4 | | | | | | | | |
| Composition | 500 g | | | | | | | |
| of Example | | | | | | | | |
| C1 | | | | | | | | |
| Composition | | 500 g | | | | | | |
| of Example | | | | | | | | |
| C2 | | | | | | | | |
| Composition | | | 500 g | | | | | |
| of Example | | | | | | | | |
| C3 | | | | | | | | |
| Composition | | | | 500 g | | | | |
| of Example | | | | | | | | |
| C4 | | | | | | | | |
| Xylene | | | | 100 g | | | 100 g | 100 g |

The coatings were applied by knifecoating with a dry film thickness of about 20 to 25 μm and were baked at 280° C. for 15 minutes. Homogeneous films were obtained in each case.

### Procedure 2 (Production of Coatings with High Dispersing Energy)

The compositions of the invention were prepared by mixing the components in accordance with Table 1. Mixing took place using a high-pressure homogenizer which produces an energy input of 200 kJ/m³.

Method of high-pressure homogenization: The constituents according to Table 2 are charged to an 80 l stainless steel batching vessel. A dispersing and suction mixer from the company Ystral (at 4500 rpm) is used for coarsely predispersing the release resins. Dispersing is completed using a Z 66 through-type rotor/stator homogenizer from Ystral with four processing rings, a stator slot width of 1 mm, and a speed of 11 500 rpm. This “preliminary” dispersion is milled using a wet jet mill, the Ultimaizer System from Sugino Machine Ltd., model HJP-25050, with a pressure of 250 MPa, a diamond nozzle diameter of 0.3 mm, and two milling passes. The energy input achieved in this case is 200 kJ/m³.

TABLE 2
Formulation of compositions (in weight fractions)
produced using a high-pressure homogenizer.

| | Coating | | | | | | | |
|---|---|---|---|---|---|---|---|---|
| | 9 | 10 | 11 | 12 | 13 | 14 | 15 | 16 |
| Composition | | | | | 50 kg | | | |
| of Example 1 | | | | | | | | |
| Composition | | | | | | 50 kg | | |
| of Example 2 | | | | | | | | |
| Composition | | | | | | | 50 kg | |
| of Example 3 | | | | | | | | |
| Composition | | | | | | | | 50 kg |
| of Example 4 | | | | | | | | |
| Composition | 50 kg | | | | | | | |
| of Example | | | | | | | | |
| C1 | | | | | | | | |
| Composition | | 50 kg | | | | | | |
| of Example | | | | | | | | |
| C2 | | | | | | | | |
| Composition | | | 50 kg | | | | | |
| of Example | | | | | | | | |
| C3 | | | | | | | | |
| Composition | | | | 50 kg | | | | |
| of Example | | | | | | | | |
| C4 | | | | | | | | |
| Xylene | | | | 10 kg | | | 10 kg | 10 kg |

The coatings were applied by knifecoating with a dry film thickness of about 20 to 25 μm and were baked at 280° C. for 15 minutes. Homogeneous films were obtained in each case.

### Test Methods:

### Release Effect:

The release effect was determined by baking a commercially customary baking mixture for cakes on the aluminum sheet coated with the compositions. The ease of removal of the cake after baking was evaluated:
0: no cake adhesion
1: slight cake adhesion
2: cake difficult to remove
3: cake largely remains adhering to the coating.

The stability of the release effect was tested by repeating the operation 100 times.

### Boiling Water Test:

An aluminum sheet coated with the composition (20 μm) was immersed for 8 hours in a container filled with boiling water. Following removal from the boiling water, the coating was examined for adhesion and blistering. The adhesion test was carried out by cross-cutting in accordance with DIN ISO 2409. Evaluation was made in accordance with the following ratings:
0: no effect after exposure
1: slight blistering and/or slight loss of adhesion
2: significant blistering and/or severe loss of adhesion.

### Temperature Stability:

The temperature stability was determined by storage at 220° C. for a period of 30 hours. The parameters examined were the yellowing resistance (visual), adhesion, and gloss retention. The adhesion test was carried out by cross-cutting in accordance with DIN ISO 2409 (ASTM D 522, ASTM D 1737—cross hatch cut method). Evaluation was made in accordance with the following ratings:
0: no effect as a result of temperature exposure
1: slight yellowing and/or slight loss of adhesion after temperature exposure
2: significant yellowing and/or severe loss of adhesion after temperature exposure.

### Storage Stability:

For the determination of storage stability after 5 weeks at 50° C., the parameters assessed were stability of the viscosity, clouding, separation phenomena, and processing properties.

### Adhesion:

The adhesion test was carried out by cross-cutting in accordance with DIN ISO 2409 (ASTM D 522, ASTM D 1737—cross hatch cut method).

### Pencil Hardness:

The pencil hardness was determined in accordance with ECCA standard T4-ISO 3270-ASTM D 3363.

### Abrasion Resistance:

Using a procedure based on DIN 53754 (ASTM D 1242—wear (Taber test)), abrasion measurements were carried out (1000 revolutions/CS 17 abrasive wheels). The parameter measured was the difference in abrasion in terms of mg of abraded material before and after abrasion exposure.

The advantages of the inventive coatings are clear from the tests conducted (Table 2 and Table 3).

TABLE 3
Properties of the coatings tested, produced using a
Dispermate (procedure 1):

| | Coating | | | | | | | |
|---|---|---|---|---|---|---|---|---|
| | 1 | 2 | 3 | 4 | 5 | 6 | 7 | 8 |
| Storage | nOK | nOK | nOK | nOK | nOK | OK | nOK | OK |
| stability | | | | | | | | |
| liquid coating | | | | | | | | |
| material (5 | | | | | | | | |
| weeks at 50° C.) | | | | | | | | |
| Release effect | 0 | 0 | 0 | 0 | 0 | 0 | 0 | 0 |
| Release effect | 0–1 | 0–1 | 2 | 1 | 0 | 0 | 0 | 0 |
| after 100 cycles | | | | | | | | |
| Boiling water | 0–1 | 0–1 | 0–1 | 3 | 0 | 0 | 0 | 0–1 |
| resistance | | | | | | | | |
| Pencil hardness | | | | | | | | |
| at room | 5H | 5H | 5H | H | 6H | 6H | 6H | 2H |
| temperature: | | | | | | | | |
| at 200° C.: | 4H | 4H | 4H | 2B | 5H | 5H | 5H | H |
| Gloss at 60° | 90/88 | 92/91 | 92/82 | 85/72 | 92/90 | 94/92 | 82/82 | 75/74 |
| (before/after | | | | | | | | |
| 100 cycles) | | | | | | | | |
| Temperature | 0 | 0 | 0 | 0 | 0 | 0 | 0 | 0 |
| stability at | | | | | | | | |
| 220° C., 30 hours | | | | | | | | |
| Abrasion | 275 mg | 159 mg | 175 mg | 179 mg | 172 mg | 109 mg | 105 mg | 98 mg |
| resistance | | | | | | | | |
| Substrate | OK | OK | OK | OK | OK | OK | OK | OK |
| adhesion | | | | | | | | |

((n)OK = (not) satisfactory)

Particularly noteworthy is the increased storage stability of coatings 6 and 8 in comparison to the filler-free coatings 1 and 4. The addition of filler produces an increase in the stability of these coatings.

TABLE 4
Properties of the coatings tested, produced using a
high-pressure homogenizer (procedure 2):

| | Coating | | | | | | | |
|---|---|---|---|---|---|---|---|---|
| | 9 | 10 | 11 | 12 | 13 | 14 | 15 | 16 |
| Storage | nOK | nOK | nOK | nOK | OK | OK | OK | OK |
| stability | | | | | | | | |
| liquid coating | | | | | | | | |
| material (5 | | | | | | | | |
| weeks at 50° C.) | | | | | | | | |
| Release effect | 0 | 0 | 0 | 0 | 0 | 0 | 0 | 0 |
| Release effect | 0–1 | 0–1 | 2 | 1 | 0 | 0 | 0 | 0 |
| after 100 cycles | | | | | | | | |
| Boiling water | 0–1 | 0–1 | 0–1 | 3 | 0 | 0 | 0 | 0–1 |
| resistance | | | | | | | | |
| Pencil hardness | | | | | | | | |
| at room | 5H | 5H | 5H | H | 6H | 6H | 6H | 2H |
| temperature: | | | | | | | | |
| at 200° C.: | 4H | 4H | 4H | 2B | 5H | 5H | 5H | H |
| Gloss at 60° | 91/89 | 91/90 | 90/80 | 84/71 | 90/84 | 93/91 | 85/80 | 78/71 |
| (before/after | | | | | | | | |
| 100 cycles) | | | | | | | | |
| Temperature | 0 | 0 | 0 | 0 | 0 | 0 | 0 | 0 |
| stability at | | | | | | | | |
| 220° C., 30 hours | | | | | | | | |
| Abrasion | 272 mg | 155 mg | 168 mg | 184 mg | 102 mg | 99 mg | 95 mg | 90 mg |
| resistance | | | | | | | | |
| Substrate | OK | OK | OK | OK | OK | OK | OK | OK |
| adhesion | | | | | | | | |

((n)OK = (not) satisfactory)

Particularly noteworthy is the increased storage stability of coatings 13 and 15 in comparison to coatings 5 and 7, which are identical in their formula. The high-pressure homogenization produces an increase in the stability of these coatings.

Having thus described in detail various embodiments of the present invention, it is to be understood that the invention defined by the above paragraphs is not to be limited to particular details set forth in the above description as many apparent variations thereof are possible without departing from the spirit or scope of the present invention.

We claim:

1. A composition for producing release coatings, comprising
(A) 100 parts by weight of one or more polysiloxane resins of the general formula
RₐSi(OR′)_{b}O_{(4-a-b)/2}
where 0<a<2, 0<b<2, and a+b<4,
(B) 0.05 to 10 parts by weight of one or more linear and/or branched polysiloxanes of the formula
R″O—[R′″₂Si—O]ₙ—R″
and
(C) 5 to 80 parts by weight of a hydroxyl-containing polyester,
where
Rₐ, R′, R″, and R′″ each independently of one another are an alkyl radical having 1 to 8 carbon atoms or an aromatic radical having 6 to 20 carbon atoms, and
n is a number in the range from 4 to 5000,
wherein
(D) 2 to 80 parts by weight of one or more nanoscale solids.

2. The composition as claimed in claim 1, wherein the radicals Rₐ, R′, R″, and R′″ each independently of one another are a radical selected from methyl, ethyl, isopropyl, n-butyl, tert-butyl, and phenyl.

3. The composition as claimed in claim 1, wherein the radical R″ is a hydrogen radical or a —Si(CH₃)₃ group.

4. The composition as claimed in claim 1, wherein the radical R′″ is a polysiloxane side chain of the general formula
—[R′″₂Si—O]ₙ—R″.

5. The composition as claimed in claim 1, containing 0.5 to 8 parts by weight of polysiloxane (B), based on 100 parts by weight of (A).

6. The composition as claimed in claim 1, containing 30 to 70 parts by weight of polyester (C), based on 100 parts by weight of (A).

7. The composition as claimed in claim 1, containing 15 to 40 parts by weight of a nanoscale solid (D), based on 100 parts by weight of (A)+(B)+(C).

8. The composition as claimed in claim 1, further comprising an esterification catalyst.

9. The composition as claimed in claim 1, further comprising pigments, rheology control agents, fillers, solvents, additives, adhesion promoters and/or stabilizers.

10. The composition as claimed in claim 1, which is obtained by simultaneously reacting components (A), (B), (C), and (D).

11. The composition as claimed in claim 10, wherein the degree of conversion is 20% to 80%.

12. A substrate coated with a composition as claimed in claim 1.

13. A process for preparing a composition as claimed in claim 1, which comprises reacting components (A), (B), (C), and (D) in the presence of a catalyst.

14. A process for preparing a composition as claimed in claim 1, which comprises preparing components (A), (B), (C), and (D) using a high-pressure homogenizer.

15. The process as claimed in claim 13, wherein the catalyst is an organotitanium catalyst.

16. The process as claimed in claim 15, wherein components (A), (B), (C), and (D) are reacted in the presence of one or more solvents.

17. The process as claimed in claim 16, wherein the reaction is carried out to a degree of conversion of 20% to 80%, based on component (B).

18. The composition of claim 2, wherein:
the radical R″ is a hydrogen radical or a —Si(CH₃)₃ group; and
the radical R′″ is a polysiloxane side chain of the general formula —[R′″₂Si—O]ₙ—R″.

19. The composition of claim 19,
containing 0.5 to 8 parts by weight of polysiloxane (B), based on 100 parts by weight of (A);
containing 30 to 70 parts by weight of polyester (C), based on 100 parts by weight of (A); and
containing 15 to 40 parts by weight of a nanoscale solid (D), based on 100 parts by weight of (A)+(B)+(C).

20. The composition of claim 11, wherein the degree of conversion is 40% to 65%.
